(19) United States
(12) Patent Application Publication
(10) Pub. No.: US 2015/0236343 A1
(43) Pub. Date: Aug. 20, 2015

(54) COATED ELECTRODES FOR LITHIUM BATTERIES

(71) Applicant: GM GLOBAL TECHNOLOGY OPERATIONS LLC, Detroit, MI (US)

(72) Inventors: Qiangfeng Xiao, Troy, MI (US); Gayatri Vyas Dadheech, Bloomfield Hills, MI (US); Li Yang, Troy, MI (US); Mei Cai, Bloomfield Hills, MI (US)

(21) Appl. No.: 14/617,471

(22) Filed: Feb. 9, 2015

Related U.S. Application Data
(60) Provisional application No. 61/941,077, filed on Feb. 18, 2014.

(51) Int. Cl. H01M 4/38; H01M 4/04; H01M 4/1391; H01M 10/052; H01M 4/48; H01M 4/62; H01M 10/0525

(52) U.S. Cl. CPC H01M 4/382; H01M 4/622; H01M 4/628; H01M 4/0426; H01M 10/0525; H01M 10/052; H01M 4/386; H01M 4/387; H01M 4/38; H01M 4/48; H01M 4/0423; H01M 4/1391; H01M 2220/10; H01M 2220/30; H01M 2220/20

(57) ABSTRACT

A coated electrode includes a negative electrode and a carbon coating adhered to a surface of the negative electrode. The negative electrode includes an active material selected from the group consisting of lithium, silicon, silicon oxide, a silicon alloy, graphite, germanium, tin, antimony, or a metal oxide; a conductive filler; and a polymer binder. The carbon coating includes a percentage of a ratio of sp² carbon:sp³ carbon ranging from 100% (100:0) to 0% (0:100).

### CROSS-REFERENCE TO RELATED APPLICATIONS

This application claims the benefit of U.S. Provisional Patent Application Ser. No. 61/941,077, filed Feb. 18, 2014, which is incorporated by reference herein in its entirety.

### BACKGROUND

Secondary, or rechargeable, lithium ion and lithium-sulfur batteries are often used in many stationary and portable devices, such as those encountered in the consumer electronic, automobile, and aerospace industries. The lithium class of batteries has gained popularity for various reasons, including a relatively high energy density, a general nonappearance of any memory effect when compared to other kinds of rechargeable batteries, a relatively low internal resistance, and a low self-discharge rate when not in use. The ability of lithium batteries to undergo repeated power cycling over their useful lifetimes makes them an attractive and dependable power source.

### SUMMARY

An example of a coated electrode includes a negative electrode and a carbon coating adhered to a surface of the negative electrode. The negative electrode includes an active material selected from the group consisting of lithium, silicon, silicon oxide, a silicon alloy, graphite, germanium, tin, antimony, or a metal oxide; a conductive filler; and a polymer binder. The carbon coating includes a percentage of a ratio of sp² carbon:sp³ carbon ranging from 100% (100:0) to 0% (0:100).

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a perspective schematic view of an example of a lithium ion battery, including an example of the negative electrode disclosed herein; and

FIG. 2 is a schematic, perspective view of an example of a lithium-sulfur battery showing a charging and discharging state, the battery including an example of the coated electrode disclosed herein;

FIG. 3 shows Raman spectra for examples of the carbon coating disclosed herein;

FIGS. 4A and 4B are Scanning Electron Micrograph (SEM) images of examples of the carbon coating disclosed herein;

FIG. 5 is a graph illustrating the resistivity of different examples of the carbon coating disclosed herein as a function of compression; and

FIG. 6 is a graph illustrating the electrochemical performance of an example coated electrode and an uncoated comparative example electrode.

### DETAILED DESCRIPTION

Lithium-sulfur and lithium ion batteries generally operate by reversibly passing lithium ions between a negative electrode (sometimes called an anode) and a positive electrode (sometimes called a cathode). The negative and positive electrodes are situated on opposite sides of a porous polymer separator soaked with an electrolyte solution that is suitable for conducting the lithium ions. Each of the electrodes is also associated with respective current collectors, which are connected by an interruptible external circuit that allows an electric current to pass between the negative and positive electrodes.

The life cycle of both lithium-sulfur and lithium ion batteries may be limited by the migration, diffusion, or shuttling of certain species from the positive electrode during the battery discharge process, through the porous polymer separator, to the negative electrode.

In lithium-sulfur batteries, this species includes lithium-polysulfide intermediates (LiSₓ, where x is 2<x<8) generated at a sulfur-based positive electrode. The lithium-polysulfide intermediates generated at the sulfur-based positive electrode are soluble in the electrolyte, and can migrate to the negative electrode where they react with the negative electrode in a parasitic fashion to generate lower-order lithium-polysulfide intermediates. These lower-order lithium-polysulfide intermediates diffuse back to the positive electrode and regenerate the higher forms of lithium-polysulfide intermediates. As a result, a shuttle effect takes place. This effect leads to decreased sulfur utilization, self-discharge, poor cycleability, and reduced coulombic efficiency of the battery. Even a small amount of lithium-polysulfide intermediates forms an insoluble molecule, such as dilithium sulfide (Li₂S), that can permanently bond to the negative electrode. This may lead to parasitic loss of active lithium at the negative electrode, which prevents reversible electrode operation and reduces the useful life of the lithium-sulfur battery.

In lithium ion batteries, this species includes transition metal cations from the positive electrode. It has been found that lithium ion batteries are deleteriously affected by the dissolution of transition metal cations from the positive electrode, which results in accelerated capacity fading, and thus loss of durability in the battery. The transition metal cations dissolve in the electrolyte and migrate from the positive electrode to the negative electrode of the battery, leading to its “poisoning”. In one example, a graphite electrode is poisoned by Mn⁺², Mn⁺³, or Mn⁴⁺ cations that dissolve from spinel LiₓMn₂O₄ of the positive electrode. For instance, the Mn⁺² cations may migrate through the battery electrolyte and porous polymer separator, and deposit onto the graphite electrode. When deposited onto the graphite, the Mn⁺² cations become Mn metal. It has been shown that a relatively small amount (e.g., 90 ppm) of Mn metal can poison the graphite electrode and prevent reversible electrode operation, thereby deleteriously affecting the useful life of the battery. The deleterious effect of the Mn deposited at the negative electrode is significantly enhanced during battery exposure to above-ambient temperatures (>40° C.), irrespective of whether the exposure occurs through mere storage (i.e., simple stand at open circuit voltage in some state of charge) or during battery operation (i.e., during charge, during discharge, or during charge-discharge cycling).

In the examples disclosed herein, the negative electrode is coated with a carbon coating that protects the negative electrode from direct attack by the lithium-polysulfide intermediates (when used in a lithium-sulfur battery) or by the transition metal cations (when used in a lithium ion battery), and reduce side reactions. As such, the carbon coating can mitigate the shuttle effect or poisoning effect, and in turn improve the efficiency and life cycle of the battery.

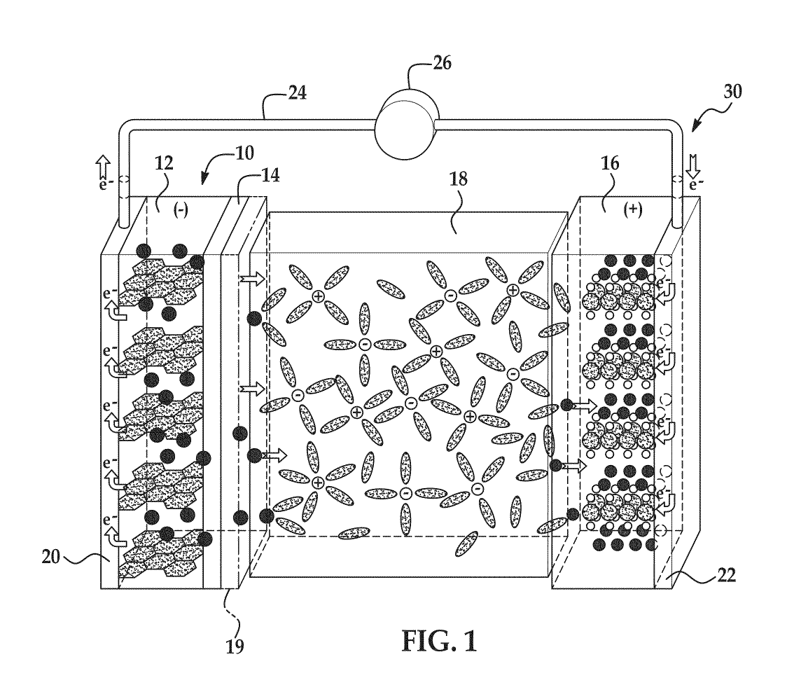

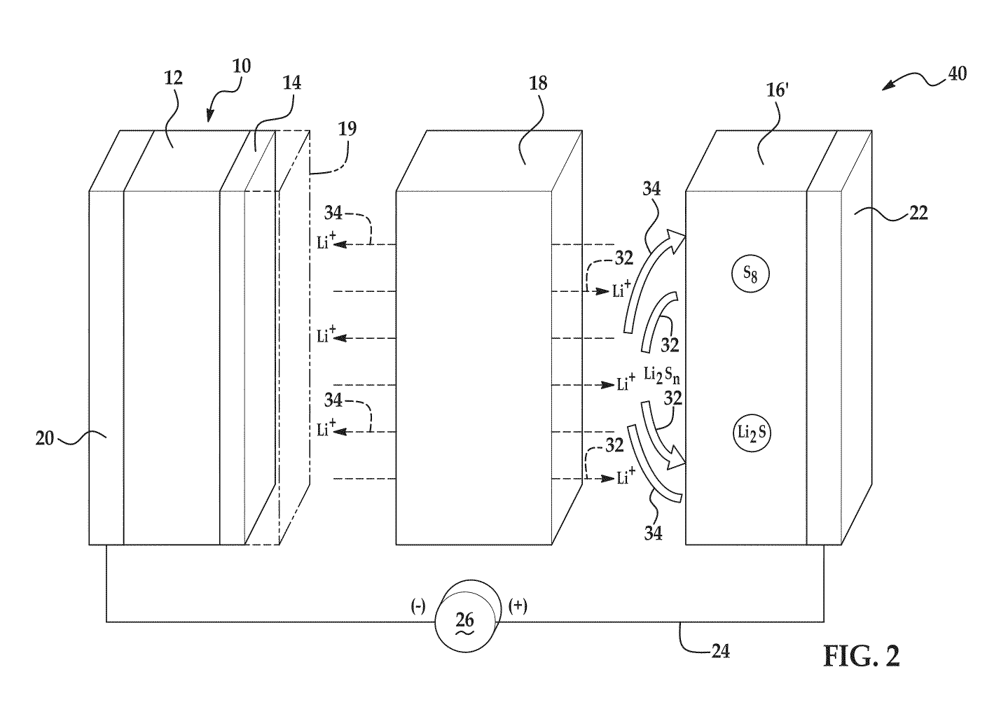

The negative electrode may include any lithium host material (i.e., active material) that can sufficiently undergo lithium intercalation and deintercalation or lithium plating and stripping while functioning as the negative terminal of a lithium ion battery (FIG. 1) or a lithium-sulfur battery (FIG. 2), respectively. Examples of the active material include crystalline silicon, amorphous silicon, silicon oxide, silicon alloys, graphite, germanium, tin, antimony, metal oxides, etc. Examples of suitable metals that may be alloyed with silicon include tin, aluminum, iron, or combinations thereof. Examples of suitable metal oxides include iron oxide (Fe₂O₃), nickel oxide (NiO), copper oxide (CuO), etc. The active material may be in the form of a powder, particles, nanowires, nanotubes, nanofibers, core shell structures, etc.

The negative electrode may also include a polymer binder material to structurally hold the active material together. Example binders include polyvinylidene fluoride (PVdF), polyethylene oxide (PEO), an ethylene propylene diene monomer (EPDM) rubber, sodium alginate, styrene-butadiene rubber (SBR), styrene-butadiene rubber carboxymethyl cellulose (SBR-CMC), polyacrylic acid (PAA), cross-linked polyacrylic acid-polyethylenimine, polyimide, polyvinyl alcohol (PVA), or carboxymethyl cellulose (CMC). Still further, the negative electrode may also include conductive filler.

The conductive filler may be a high surface area carbon, such as acetylene black, that ensures electron conduction between the active material and, for example, a negative-side current collector operatively connected to the negative electrode. Other examples of suitable conductive fillers, which may be used alone or in combination with carbon black, include graphene, graphite, carbon nanotubes, and/or carbon nanofibers. One specific example of a combination of conductive fillers is carbon black and carbon nanofibers. The negative-side current collector may be formed from copper or any other appropriate electrically conductive material known to skilled artisans.

The negative electrode may include about 40% by weight to about 90% by weight (i.e., 90 wt %) of the active material. The negative electrode may include 0% by weight to about 30% by weight of the conductive filler. Additionally, the negative electrode may include 0% by weight to about 20% by weight of the polymer binder. In an example, the negative electrode includes about 70 wt % of the active material, about 15 wt % of the conductive filler, and about 15 wt % of the polymer binder material.

The carbon coating is a porous, continuous coating formed on one or more surfaces of the negative electrode. In an example, the porous, continuous carbon coating encapsulates the entire negative electrode. In another example, the continuous carbon coating is formed on a surface of the negative electrode that is to face the separator in the lithium ion battery or the lithium-sulfur battery.

The carbon coating may be formed by simultaneously exposing a solid graphite target to a plasma treatment and an evaporation treatment. The simultaneous plasma and evaporation treatments may be accomplished using pulsed laser deposition, a combination of cathodic arc deposition and laser arc deposition, a combination of plasma exposure and electron beam (e-beam) exposure, a combination of plasma exposure and laser arc deposition, magnetron sputtering, or plasma enhanced physical vapor deposition (PE-PVD). In an example, the maximum deposition rate ranges from about 48 nm/min to about 100 nm/min, which can be achieved with a pulse repetition rate ranging from about 1 kHz to about 10 kHz.

The combination of these treatments evaporates the solid graphite target and deposits sp² carbon (i.e., graphite) and sp³ carbon (i.e., diamond) on the negative electrode. A percentage of the ratio of sp² carbon to sp³ carbon in the carbon coating ranges from 100% (100:0) to 0% (0:100). In an example, the ratio of sp² carbon to sp³ carbon in the carbon coating is 74:26.

The combination plasma and evaporation treatment disclosed herein may be controlled by adjusting the parameters of the plasma and evaporation treatment to produce a highly graphitic carbon coating or a highly amorphous carbon coating. The highly graphitic carbon coating has a higher sp² carbon content. The higher sp² carbon content increases the energy density of the carbon layer. As an example, the amount of sp² carbon in the example carbon coatings disclosed herein is about 25% higher than the amount of sp² carbon in carbon coatings formed using standard sputtering techniques. In some examples, the carbon coating has a gradient of sp² carbon and sp³ carbon. For example, during the initial deposition, both sp² carbon and sp³ carbon may be formed, and then as deposition continues, primarily sp² carbon may be formed. In an example of forming this gradient (e.g., moving from a combination of sp² carbon and sp³ carbon to primarily sp² carbon), the initial treatment temperature may be about 50° C., and then slowly increased to about 500° C.

As mentioned above, the simultaneous plasma treatment and evaporation treatment begins with a solid graphite target. In order to alter the properties of the carbon coating and the carbon phase (e.g., graphitic, less graphitic, diamond-like, amorphous) that are formed, the parameters of the process may be altered. For example, some parameters that may be adjusted include the base pressure, the power of the plasma treatment, and the treatment temperature (i.e., sample stage temperature). In an example, the base pressure may be adjusted to be in a range of about 3 mTorr to about 20 mTorr. In another example, the power of the plasma treatment may be adjusted to be in a range of about 20 W to about 300 W. In yet another example, the treatment temperature may be adjusted to be in a range of about 50° C. to about 500° C. In a specific example, lowering the treatment temperature (e.g., closer to 50° C.) can result in the formation of a primarily amorphous carbon coating (i.e., high sp³ carbon phases). In another specific example, the initial phases that are formed include the sp² carbon and sp³ carbon, and then the treatment temperature may be increased (e.g., closer to 500° C.) so that a remainder of the carbon coating is primarily graphitic carbon (i.e., the sp² carbon phase).

The arc discharges of plasma and evaporation may be controlled to control the thickness of the carbon coating. The thickness of the carbon coating may range from about 1 nm to about 1 μm. As one example, the carbon coating thickness may be about 8 nm.

The carbon coatings disclosed herein also exhibit desirable properties that contribute to the mechanical strength and integrity of the negative electrode. For example, the carbon coating may have a Young's modulus ranging from about 5 GPa to about 200 GPa, a hardness ranging from about 1 GPa to about 20 GPa, and a density of about 2.23 g cm⁻³.

The carbon coating disclosed herein also adheres to the negative electrode. This adhesion enables the carbon coating to serve as a physical protection layer. This is unlike a free standing carbon layer.

Both the negative electrode and the carbon coating formed thereon may be pre-lithiated before being used in a lithium ion battery or a lithium-sulfur battery. Any suitable electrolyte including a lithium salt may be used for pre-lithiation. Examples of the electrolytes given below in reference to FIGS. 1 and 2 may be used to pre-lithiate the negative electrode. In an example, pre-lithiation is performed with 1 M LiPF₆ in dimethoxyethane (DME):fluoroethylene carbonate (FEC) with a volume ratio of 3:1.

The negative electrode and carbon coating may be pre-lithiated using a half cell. More specifically, the half cell is assembled using the carbon coated negative electrode, which is soaked in the pre-lithiation electrolyte previously described. A voltage potential is applied to the half cell, which causes lithium metal to penetrate the carbon coating and the negative electrode. The resulting carbon coating has a controlled thickness and is like an artificial solid electrolyte interphase (SEI) layer in that it can transport both electrons and lithium ions.

During pre-lithiation, it is to be understood that another SEI layer 19 may form between the pre-lithiation electrolyte and the carbon coating. This other SEI layer 19 forms from i) electrolyte components decomposing when exposed to a low voltage potential, and ii) the electrolyte decomposition products depositing on the exposed surfaces of the carbon coating.

After pre-lithiation is complete, the half cell is disassembled and the negative electrode may be washed using a suitable solvent, such as DME.

As mentioned above, the carbon coated negative electrode can be used in either a lithium ion battery or a lithium-sulfur batter. FIG. 1 illustrates an example of the lithium ion battery 30 and FIG. 2 illustrates an example of the lithium-sulfur battery 40. Each of these figures will be discussed separately below.

The lithium ion battery 30 of FIG. 1 includes the coated electrode 10 (i.e., the negative electrode 12 with the carbon coating 14 adhered thereto and, in some instances, another SEI layer 19), a negative side current collector 20, a positive electrode 16, a positive-side current collector 22, and a porous separator 18 positioned between the coated electrode 10 and the positive electrode 16. As illustrated in FIG. 1, the carbon coating 14 faces the porous separator 18.

The positive electrode 16 may be formed from any lithium-based active material that can sufficiently undergo lithium insertion and deinsertion while a suitable current collector 22 is functioning as the positive terminal of the lithium ion battery 30. One common class of known lithium-based active materials suitable for the positive electrode 16 includes layered lithium transitional metal oxides. Some specific examples of the lithium-based active materials include spinel lithium manganese oxide (LiMn₂O₄), lithium cobalt oxide (LiCoO₂), a nickel-manganese oxide spinel [Li(Ni_{0.5}Mn_{1.5})O₂], a layered nickel-manganese-cobalt oxide [Li(NiₓMn_{y}Co_{z})O₂], or a lithium iron polyanion oxide, such as lithium iron phosphate (LiFePO₄) or lithium iron fluorophosphate (Li₂FePO₄F). Other lithium-based active materials may also be utilized, such as lithium nickel-cobalt oxide (LiNiₓCo₁₋ₓO₂), aluminum stabilized lithium manganese oxide spinel (LiₓMn₂₋ₓAl_{y}O₄), lithium vanadium oxide (LiV₂O₅), Li₂MSiO₄ (M is composed of any ratio of Co, Fe, and/or Mn), xLi₂MnO₃₋(1−x)LiMO₂ (M is composed of any ratio of Ni, Mn and/or Co), and any other high efficiency nickel-manganese-cobalt material. By “any ratio” it is meant that any element may be present in any amount. So, for example M could be Al, with or without Co and/or Mg, or any other combination of the listed elements.

The lithium-based active material of the positive electrode 16 may be intermingled with a polymeric binder and a high surface area carbon. Suitable binders include polyvinylidene fluoride (PVdF), polyethylene oxide (PEO), an ethylene propylene diene monomer (EPDM) rubber, carboxymethyl cellulose (CMC), styrene-butadiene rubber (SBR), styrene-butadiene rubber carboxymethyl cellulose (SBR-CMC), polyacrylic acid (PAA), cross-linked polyacrylic acid-polyethylenimine, polyimide, polyvinyl alcohol (PVA), sodium alginate, or other water-soluble binders. The polymeric binder structurally holds the lithium-based active materials and the high surface area carbon together.

An example of the high surface area carbon is acetylene black (i.e., carbon black). Other examples of suitable conductive fillers, which may be used alone or in combination with carbon black, include graphene, graphite, carbon nanotubes, and/or carbon nanofibers. One specific example of a combination of conductive fillers is carbon black and carbon nanofibers. The high surface area carbon ensures electron conduction between the positive-side current collector 22 and the active material particles of the positive electrode 16.

The positive electrode 16 may include about 40% by weight to about 90% by weight (i.e., 90 wt %) of the lithium-based active material. The positive electrode 16 may include 0% by weight to about 30% by weight of the conductive filler. Additionally, the positive electrode 14 may include 0% by weight to about 20% by weight of the polymer binder. In an example, the positive electrode 16 includes about 85 wt % of the lithium-based active material, about 10 wt % of the conductive carbon material, and about 5 wt % of the polymer binder material.

The positive-side current collector 22 may be formed from aluminum or any other appropriate electrically conductive material known to skilled artisans.

The porous separator 18, which operates as both an electrical insulator and a mechanical support, is sandwiched between the coated electrode 10 and the positive electrode 16 to prevent physical contact between the two electrodes 10, 16 and the occurrence of a short circuit. In addition to providing a physical barrier between the two electrodes 10, 16, the porous separator 18 ensures passage of lithium ions (identified by the black dots and by the open circles having a (+) charge in FIG. 1) and related anions (identified by the open circles having a (−) charge in FIG. 1) through an electrolyte solution filling its pores. This helps ensure that the lithium ion battery 30 functions properly.

The porous separator 18 may be a polyolefin membrane. The polyolefin may be a homopolymer (derived from a single monomer constituent) or a heteropolymer (derived from more than one monomer constituent), and may be either linear or branched. If a heteropolymer derived from two monomer constituents is employed, the polyolefin may assume any copolymer chain arrangement, including those of a block copolymer or a random copolymer. The same holds true if the polyolefin is a heteropolymer derived from more than two monomer constituents. As examples, the polyolefin membrane may be formed of polyethylene (PE), polypropylene (PP), a blend of PE and PP, or multi-layered structured porous films of PE and/or PP. Commercially available porous separators 18 include single layer polypropylene membranes, such as CELGARD 2400 and CELGARD 2500 from Celgard, LLC (Charlotte, N.C.). It is to be understood that the porous separator 18 may be coated or treated, or uncoated or untreated. For example, the porous separator 18 may or may not be coated or include any surfactant treatment thereon.

In other examples, the porous separator 18 may be formed from another polymer chosen from polyethylene terephthalate (PET), polyvinylidene fluoride (PVdF), polyamides (Nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, acrylonitrile-butadiene styrene copolymers (ABS), polystyrene copolymers, polymethylmethacrylate (PMMA), polyvinyl chloride (PVC), polysiloxane polymers (such as polydimethylsiloxane (PDMS)), polybenzimidazole (PBI), polybenzoxazole (PBO), polyphenylenes (e.g., PARMAX™ (Mississippi Polymer Technologies, Inc., Bay Saint Louis, Miss.)), polyarylene ether ketones, polyperfluorocyclobutanes, polytetrafluoroethylene (PTFE), polyvinylidene fluoride copolymers and terpolymers, polyvinylidene chloride, polyvinylfluoride, liquid crystalline polymers (e.g., VECTRAN™ (Hoechst AG, Germany), ZENITE® (DuPont, Wilmington, Del.), poly(p-hydroxybenzoic acid), polyaramides, polyphenylene oxide, and/or combinations thereof. In yet another example, the porous separator 18 may be chosen from a combination of the polyolefin (such as PE and/or PP) and one or more of the polymers listed above.

The porous separator 18 may contain a single layer or a multi-layer laminate fabricated from either a dry or wet process. For example, a single layer of the polyolefin and/or other listed polymer may constitute the entirety of the porous separator 18. As another example, however, multiple discrete layers of similar or dissimilar polyolefins and/or polymers may be assembled into the porous separator 18. In one example, a discrete layer of one or more of the polymers may be coated on a discrete layer of the polyolefin to form the porous separator 18. Further, the polyolefin (and/or other polymer) layer, and any other optional polymer layers, may further be included in the porous separator 18 as a fibrous layer to help provide the porous separator 18 with appropriate structural and porosity characteristics. Still other suitable separators 18 include those that have a ceramic layer attached thereto, and those that have ceramic filler in the polymer matrix (i.e., an organic-inorganic composite matrix). In still other instances, a ceramic membrane, such as Al₂O₃, Si₃N₄, and SiC, itself may be used as the separator 18.

Still other suitable porous separators 18 include those that have a ceramic layer attached thereto, and those that have ceramic filler in the polymer matrix (i.e., an organic-inorganic composite matrix).

Any appropriate electrolyte solution that can conduct lithium ions between the coated electrode 10 and the positive electrode 16 may be used in the lithium ion battery 30. In one example, the electrolyte solution may be a non-aqueous liquid electrolyte solution that includes a lithium salt dissolved in an organic solvent or a mixture of organic solvents. Skilled artisans are aware of the many non-aqueous liquid electrolyte solutions that may be employed in the lithium ion battery 30 as well as how to manufacture or commercially acquire them. Examples of lithium salts that may be dissolved in an organic solvent to form the non-aqueous liquid electrolyte solution include LiClO₄, LiAlCl₄, LiI, LiBr, LiSCN, LiBF₄, LiB(C₆H₅)₄, LiAsF₆, LiCF₃SO₃, LiN(FSO₂)₂, LiN(CF₃SO₂)₂ (LiTFSI), LiPF₆, LiPF₄(C₂O₄) (LiFOP), LiNO₃, LiB(C₂O₄)₂ (LiBOB), LiBF₂(C₂O₄) (LiODFB), LiN(FSO₂)₂ (LiFSI), LiPF₃(C₂F₅)₃ (LiFAP), LiPF₄(CF₃)₂, LiPF₃(CF₃)₃, and mixtures thereof. These and other similar lithium salts may be dissolved in a variety of organic solvents, such as cyclic carbonates (ethylene carbonate, propylene carbonate, butylene carbonate), linear carbonates (dimethyl carbonate, diethyl carbonate, ethylmethyl carbonate), aliphatic carboxylic esters (methyl formate, methyl acetate, methyl propionate), γ-lactones (γ-butyrolactone, γ-valerolactone), chain structure ethers (1,2-dimethoxyethane, 1-2-diethoxyethane, ethoxymethoxyethane, tetraglyme), cyclic ethers (tetrahydrofuran, 2-methyltetrahydrofuran,1,3-dioxolane), and mixtures thereof.

As shown in FIG. 1, the lithium ion battery 30 also includes an interruptible external circuit 24 that connects the negative electrode 12 and the positive electrode 16. The lithium ion battery 30 may also support a load device 26 that can be operatively connected to the external circuit 24. The load device 26 receives a feed of electrical energy from the electric current passing through the external circuit 24 when the lithium ion battery 30 is discharging. While the load device 26 may be any number of known electrically-powered devices, a few specific examples of a power-consuming load device include an electric motor for a hybrid vehicle or an all-electrical vehicle, a laptop computer, a cellular phone, and a cordless power tool. The load device 26 may also, however, be an electrical power-generating apparatus that charges the lithium ion battery 30 for purposes of storing energy. For instance, the tendency of windmills and solar panels to variably and/or intermittently generate electricity often results in a need to store surplus energy for later use.

The lithium ion battery 30 may also include a wide range of other components that, while not depicted here, are nonetheless known to skilled artisans. For instance, the lithium ion battery 30 may include a casing, gaskets, terminals, tabs, and any other desirable components or materials that may be situated between or around the coated electrode 10 and the positive electrode 16 for performance-related or other practical purposes. Moreover, the size and shape of the lithium ion battery 30, as well as the design and chemical make-up of its main components, may vary depending on the particular application for which it is designed. Battery-powered automobiles and hand-held consumer electronic devices, for example, are two instances where the lithium ion battery 30 would most likely be designed to different size, capacity, and power-output specifications. The lithium ion battery 30 may also be connected in series and/or in parallel with other similar lithium ion batteries to produce a greater voltage output and current (if arranged in parallel) or voltage (if arranged in series) if the load device 26 so requires.

The lithium ion battery 30 generally operates by reversibly passing lithium ions between the negative electrode 12 and the positive electrode 16. In the fully charged state, the voltage of the battery 30 is at a maximum (typically in the range 2.0 to 5.0V); while in the fully discharged state, the voltage of the battery 30 is at a minimum (typically in the range 1.0 to 3.0V). Essentially, the Fermi energy levels of the active materials in the positive and negative electrodes 16, 12 change during battery operation, and so does the difference between the two, known as the battery voltage. The battery voltage decreases during discharge, with the Fermi levels getting closer to each other. During charge, the reverse process is occurring, with the battery voltage increasing as the Fermi levels are being driven apart. During battery discharge, the external load device 26 enables an electronic current flow in the external circuit 24 with a direction such that the difference between the Fermi levels (and, correspondingly, the cell voltage) decreases. The reverse happens during battery charging: the battery charger forces an electronic current flow in the external circuit 24 with a direction such that the difference between the Fermi levels (and, correspondingly, the cell voltage) increases.

At the beginning of a discharge, the coated electrode 10 of the lithium ion battery 30 contains a high concentration of intercalated lithium while the positive electrode 16 is relatively depleted. When the coated electrode 10 contains a sufficiently higher relative quantity of intercalated lithium, the lithium ion battery 30 can generate a beneficial electric current by way of reversible electrochemical reactions that occur when the external circuit 24 is closed to connect the coated electrode 10 and the positive electrode 16. The establishment of the closed external circuit under such circumstances causes the extraction of intercalated lithium from the coated electrode 10. The extracted lithium atoms are split into lithium ions (identified by the black dots and by the open circles having a (+) charge) and electrons (e⁻) as they leave an intercalation host at the negative electrode-electrolyte interface.

The chemical potential difference between the positive electrode 16 and the coated electrode 10 (ranging from about 2.0 volts to about 5.0 volts, depending on the exact chemical make-up of the electrodes 16, 10) drives the electrons (e⁻) produced by the oxidation of intercalated lithium at the coated electrode 10 through the external circuit 24 towards the positive electrode 16. The lithium ions are concurrently carried by the electrolyte solution through the porous separator 18 towards the positive electrode 16. The electrons (e⁻) flowing through the external circuit 24 and the lithium ions migrating across the porous separator 18 in the electrolyte solution eventually reconcile and form intercalated lithium at the positive electrode 16. The electric current passing through the external circuit 24 can be harnessed and directed through the load device 26 until the level of intercalated lithium in the coated electrode 10 falls below a workable level or the need for electrical energy ceases.

The lithium ion battery 30 may be recharged after a partial or full discharge of its available capacity. To charge the lithium ion battery 30, an external battery charger is connected to the positive and the coated electrodes 16, 10, to drive the reverse of battery discharge electrochemical reactions. During recharging, the electrons (e⁻) flow back towards the coated electrode 10 through the external circuit 24, and the lithium ions are carried by the electrolyte across the porous separator 18 back towards the coated electrode 10. The electrons (e⁻) and the lithium ions are reunited at the negative electrode 12, thus replenishing it with intercalated lithium for consumption during the next battery discharge cycle.

The external battery charger that may be used to charge the lithium ion battery 30 may vary depending on the size, construction, and particular end-use of the lithium ion battery 30. Some suitable external battery chargers include a battery charger plugged into an AC wall outlet and a motor vehicle alternator.

As previously described, the carbon coating 14 mitigates or prevents the direct attack of the negative electrode 12 with transition metal cations that are dissolved in the electrolyte.

Referring now to FIG. 2, an example of the lithium-sulfur battery 40 is depicted including an example of the coated electrode 10 (including the negative electrode 12 and the carbon coating 14).

In the lithium-sulfur battery 40, the positive electrode 16′ may be formed from any sulfur-based active material that can sufficiently undergo lithium plating and stripping while the positive-side current collector 22 functions as the positive terminal of the battery 40. In an example, the sulfur based active material may be a sulfur-carbon composite. In an example, the weight ratio of S to C in the positive electrode 16′ ranges from 1:9 to 8:1.

The positive electrode 16′ may also include a polymer binder material to structurally hold the sulfur-based active material together. The polymer binder material may be made of at least one of polyvinylidene fluoride (PVdF), polyethylene oxide (PEO), an ethylene propylene diene monomer (EPDM) rubber, carboxymethyl cellulose (CMC), styrene-butadiene rubber (SBR), styrene-butadiene rubber carboxymethyl cellulose (SBR-CMC), polyacrylic acid (PAA), cross-linked polyacrylic acid-polyethylenimine, polyimide, polyvinyl alcohol (PVA), or sodium alginate or other water-soluble binders. Still further, the positive electrode 16′ may include a conductive carbon material. In an example, the conductive carbon material is a high surface area carbon, such as acetylene black. Other examples of suitable conductive fillers, which may be used alone or in combination with carbon black, include graphene, graphite, carbon nanotubes, and/or carbon nanofibers. One specific example of a combination of conductive fillers is carbon black and carbon nanofibers.

The positive electrode 16′ may include from about 40% by weight to about 90% by weight (i.e., 90 wt %) of the sulfur-based active material. The positive electrode 16′ may include 0% by weight to about 30% by weight of the conductive filler. Additionally, the positive electrode 16′ may include 0% by weight to about 20% by weight of the polymer binder. In an example, the positive electrode 16′ includes about 85 wt % of the sulfur-based active material, about 10 wt % of the conductive carbon material, and about 5 wt % of the polymer binder material.

The lithium-sulfur battery 40 includes the separator 18 positioned between the coated electrode 10 and the positive electrode 16′. The separator 18 may be a single layer or a multi-layer laminate, and may be any of the polyolefins or other polymers previously described. The porous separator 18 operates as an electrical insulator (preventing the occurrence of a short), a mechanical support, and a barrier to prevent physical contact between the two electrodes 10, 16′. The porous separator 18 also ensures passage of lithium ions (identified by the Li⁺) through an electrolyte filling its pores.

The coated electrode 10 and the positive electrode 16′ are also respectively in contact with a negative-side current collector 20 and a positive-side current collector 22. Any of the examples previously described may be used.

Each of the positive electrode 16′, the coated electrode 10, and the porous polymer separator 18 are soaked in an electrolyte solution. Any appropriate electrolyte solution that can conduct lithium ions between the positive electrode 16′ and the coated electrode 10 may be used in the lithium-sulfur battery 40. In one example, the non-aqueous electrolyte solution may be an ether based electrolyte that is stabilized with lithium nitrite. Other non-aqueous liquid electrolyte solutions may include a lithium salt dissolved in an organic solvent or a mixture of organic solvents. Examples of lithium salts that may be dissolved in the ether to form the non-aqueous liquid electrolyte solution include LiClO₄, LiAlCl₄, LiI, LiBr, LiSCN, LiBF₄, LiB(C₆H₅)₄, LiCF₃SO₃, LiN(FSO₂)₂ (LIFSI), LiN(CF₃SO₂)₂ (LIFSI), LiAsF₆, LiPF₆, LiB(C₂O₄)₂ (LiBOB), LiBF₂(C₂O₄) (LiODFB), LiSCN, LiPF₄(C₂O₄) (LiFOP), LiNO₃, and mixtures thereof. The ether based solvents may be composed of cyclic ethers, such as 1,3-dioxolane, tetrahydrofuran, 2-methyltetrahydrofuran, and chain structure ethers, such as 1,2-dimethoxyethane, 1-2-diethoxyethane, ethoxymethoxyethane, tetraethylene glycol dimethyl ether (TEGDME), polyethylene glycol dimethyl ether (PEGDME), and mixtures thereof.

The lithium-sulfur battery 40 also includes the interruptible external circuit 24 that connects the positive electrode 16′ and the coated electrode 10. The lithium-sulfur battery 40 may also support the load device 26 that can be operatively connected to the external circuit 24. The load device 26 may be receives a feed of electrical energy from the electric current passing through the external circuit 24 when the lithium-sulfur battery 40 is discharging. Any of the previously described load devices 26 for the lithium ion battery 30 may be used.

The lithium-sulfur battery 40 can include a wide range of other components, such as those previously described for the lithium ion battery 30. Moreover, the size and shape of the lithium-sulfur battery 40, as well as the design and chemical make-up of its main components, may vary depending on the particular application for which it is designed. Battery-powered automobiles and hand-held consumer electronic devices, for example, are two instances where the lithium-sulfur battery 40 would most likely be designed to different size, capacity, and power-output specifications. The lithium-sulfur battery 40 may also be connected in series and/or in parallel with other similar lithium-sulfur batteries 40 to produce a greater voltage output and current (if arranged in parallel) or voltage (if arranged in series) if the load device 26 so requires.

The lithium-sulfur battery 40 can generate a useful electric current during battery discharge (shown by reference numeral 32 in FIG. 2). During discharge, the chemical processes in the battery 30 include lithium (Li⁺) dissolution from the surface of the coated electrode 10 and incorporation of the lithium cations into alkali metal polysulfide salts (i.e., Li₂Sₙ, such as Li₂S₈, Li₂S₆, Li₂S₄, Li₂S₂, and Li₂S) within the positive electrode 16′. As such, polysulfides are formed (sulfur is reduced) within the positive electrode 16′ in sequence while the battery 40 is discharging. The chemical potential difference between the positive electrode 16′ and the coated electrode 10 (ranging from approximately 1.5 to 3.0 volts, depending on the exact chemical make-up of the electrodes 16′, 10) drives electrons produced by the dissolution of lithium at the coated electrode 10 through the external circuit 24 towards the positive electrode 16′. The resulting electric current passing through the external circuit 24 can be harnessed and directed through the load device 26 until the lithium in the coated electrode 10 is depleted and the capacity of the lithium-sulfur battery 40 is diminished.

The lithium-sulfur battery 40 can be charged or re-powered at any time by applying an external power source to the lithium-sulfur battery 40 to reverse the electrochemical reactions that occur during battery discharge. During charging (shown at reference numeral 34 in FIG. 2), lithium plating to the coated electrode 10 takes place and sulfur formation within the positive electrode 16′ takes place. The connection of an external power source to the lithium-sulfur battery 40 compels the otherwise non-spontaneous oxidation of lithium at the positive electrode 16′ to produce electrons and lithium ions. The electrons, which flow back towards the coated electrode 10 through the external circuit 24, and the lithium ions (Li⁺), which are carried by the electrolyte across the porous polymer separator 18 back towards the coated electrode 10, reunite at the coated electrode 10 and replenish it with lithium for consumption during the next battery discharge cycle. The external power source that may be used to charge the lithium-sulfur battery 40 may vary depending on the size, construction, and particular end-use of the lithium-sulfur battery 40. Some suitable external power sources include a battery charger plugged into an AC wall outlet and a motor vehicle alternator.

As previously described, the carbon coating 14 mitigates or prevents the polysulfide shuffling during charging/discharging.

Examples of the batteries 30, 40 may be used in a variety of different applications. For example the batteries 30, 40 may be used in different devices, such as a battery operated or hybrid vehicle, a laptop computer, a cellular phone, a cordless power tool, or the like.

To further illustrate the present disclosure, an example is given herein. It is to be understood that this example is provided for illustrative purposes and is not to be construed as limiting the scope of the disclosed example(s).

### EXAMPLE

Several carbon coatings were prepared according to the example method disclosed herein. To form the carbon coatings, a laser-Arc technology system was used. The laser-arc technology system components included a main (water-cooled) Laser-Arc Module (LAM) vacuum chamber, a pulsed solid-state Nd:YAG laser (wavelength 1.06 μm, pulse length 150 ns, 10 kHz repetition rate, average pulse power density 15 mJ cm⁻²), a pulsed power supply (peak current 2 kA, pulse length 100 μs, repetition rate 1.8 kHz, average current 260 A), and a software/hardware controller. The water-cooled LAM chamber housed a cylindrical (160 mm diameter, up to 500 mm length) graphite target and a rod-shaped anode for the arc discharge. The graphite target was electrically the cathode for the arc discharge. The cathode and the anode were externally connected to a charged capacitor bank in the pulse power supply.

The laser pulses aimed through a window into the LAM chamber and focused onto the surface of the graphite cylinder target. The 150 ns laser pulse generated a rapidly expanding carbon plasma plume, which in turn ignited a 150 μs vacuum arc discharge pulse between graphite target (cathode) and the anode. The vacuum arc discharge was the main energy source to evaporate the graphite. The power supply's pulse forming components were designed to adjust the maximal arc current of several kA, timing, and pulse shape. Combining a rotation of the target with a linear scan of the laser pulse along the length of the target ensured very uniform target erosion and film deposition.

Carbon thin films/coatings were reproducibly deposited over a wide thickness range from a few nanometers to tens of micrometers. Film/coating thickness control was accomplished by adjusting the number of ignited arc discharges. A single laser can be used to ignite several arc sources for boosting deposition rates in commercial systems for carbon coating deposition.

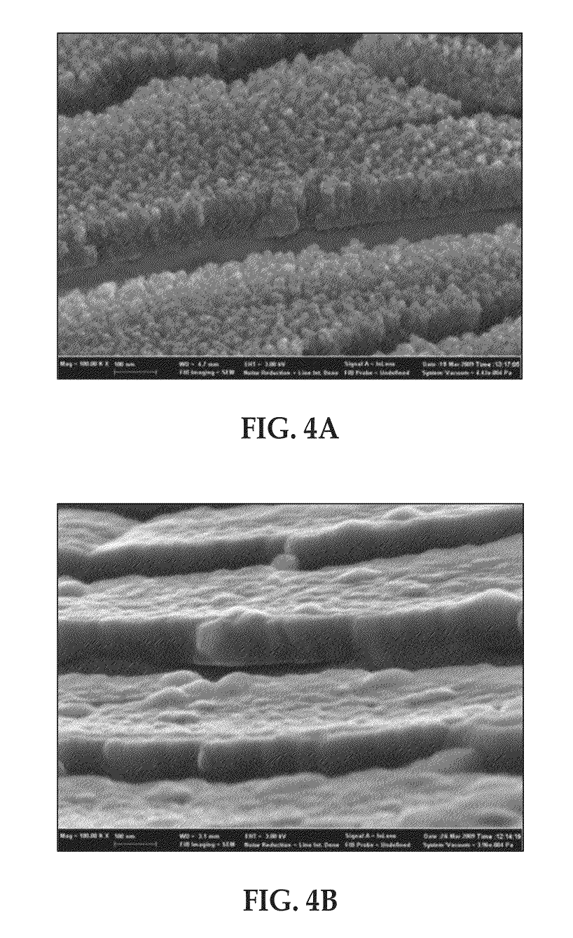

SEM images of two of these coatings are shown in FIGS. 4A and 4B.

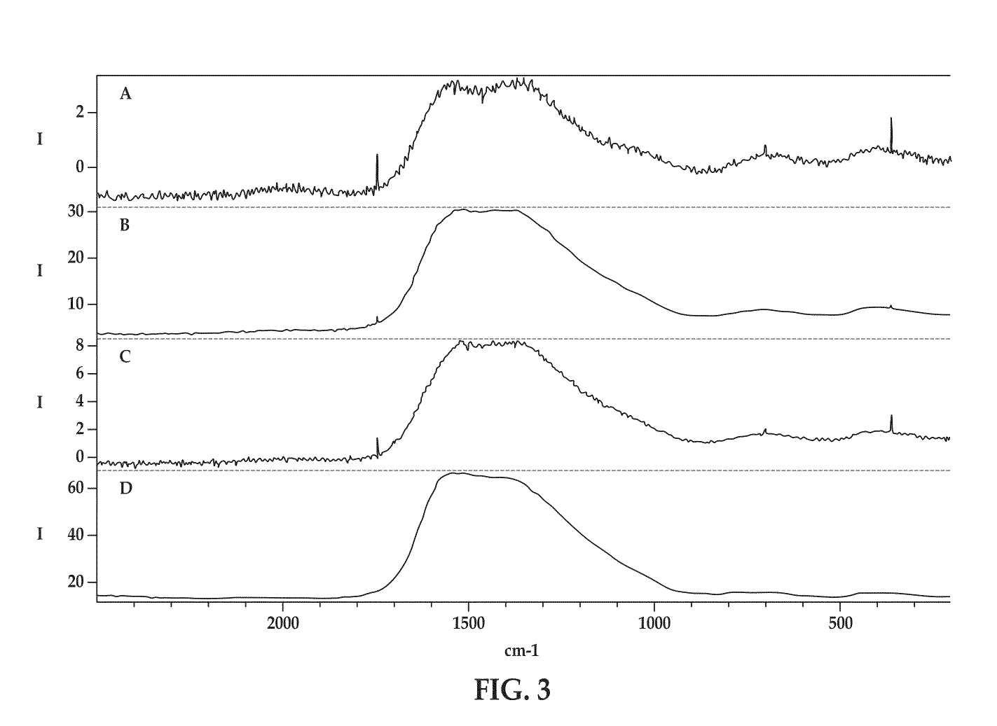

The Raman spectra for the carbon coatings shown in FIGS. 4A and 4B were also obtained. These results are shown in FIG. 3 (Intensity “I” on the Y axis and Raman Shift (cm⁻¹) on the X axis). The top two spectra (A, B) are for the example carbon coating shown in FIG. 4A, and the bottom two spectra (C, D) are for the example carbon coating shown in FIG. 4B. Spectra A and C exhibit the Raman shift results for non-tested areas of the respective carbon coatings, and spectra B and D exhibit the Raman shift results for tested areas of the respective carbon coatings. The tested areas were tested under ex-situ potentiostatic cycling while the non-tested areas were pristine coatings. Comparing the results of B with A and D with C, it can be concluded that the coating structures and properties do not change when exposed to potentiostatic cycling, which indicates that the coatings are stable.

In each of the spectra, the peaks at about 1500 cm⁻¹ and about 1360 cm⁻¹ are indicative of the sp² and sp^{a} carbons.

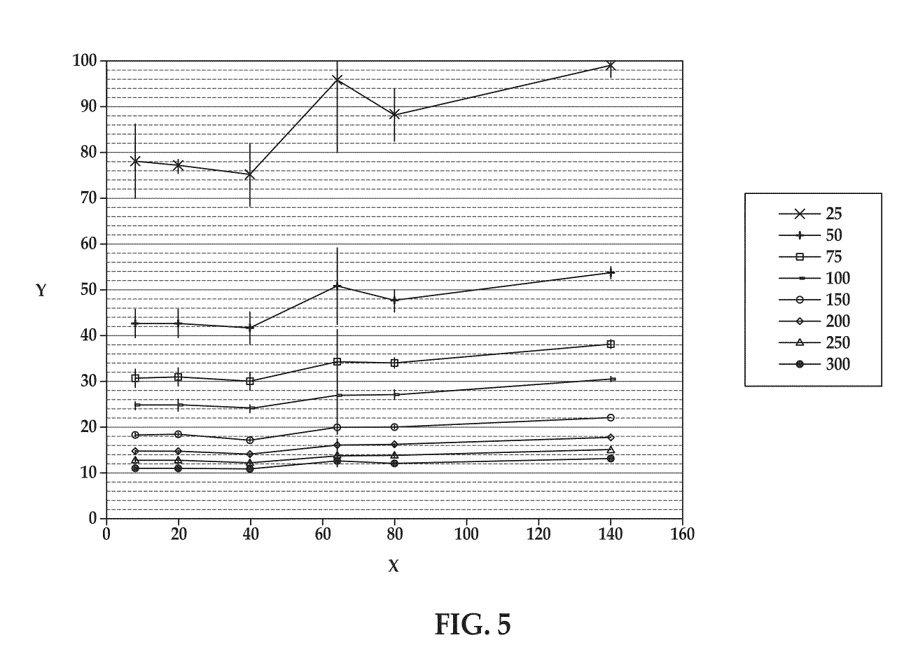

The specific contact resistivity of the carbon coatings having varying thicknesses was tested at different compression levels (the levels tested included, 25 PSI, 50 PSI, 75 PSI, 100 PSI, 150 PSI, 200 PSI, 250 PSI, and 300 PSI). These results are shown in FIG. 5. The specific contact resistivity in mOhm·cm² is shown on the Y axis (labeled “Y”) and the carbon film/coating thickness in nm is shown on the X axis (labeled “X”). The key identifies the compression level PSI that was used. As illustrated, as the compression pressure increased (regardless of the thickness of the coating), the contact resistivity of the carbon coating was lowered.

Using the method described in this example, a carbon coating with a thickness of 25 nm was coated on a silicon-based negative electrode. A pristine (uncoated) silicon-based negative electrode was used as a comparative example. Example and comparative example electrochemical cells were prepared. The example electrochemical cell included the carbon coated negative electrode paired with a lithium counter electrode. The comparative electrochemical cell included the pristine negative electrode paired with a lithium counter electrode. The electrolyte in each of the example and comparative example electrochemical cells included 1M LiPF₆ in ethylene carbonate/dimethoxyethane (EC/DMC, v/v=1/2) with 10 vol % FEC.

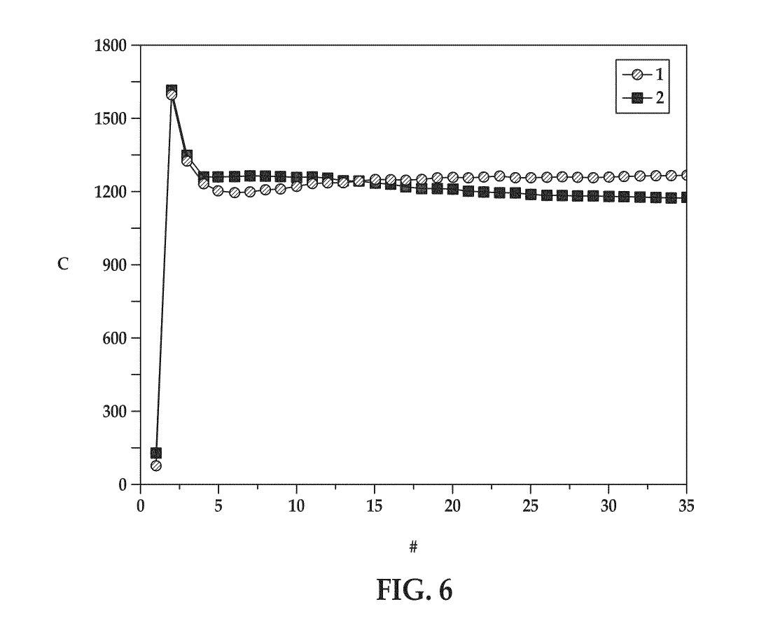

The test conditions for the comparative and example cells were: room temperature; current rate=0.1 C; and voltage cutoff ranging from 0.05V to 1V. The charge capacity results are shown in FIG. 6. In FIG. 6, the Y axis, labeled C, represents the charge capacity (mAh/g) and the X axis, labeled “#,” represents the cycle number.

As illustrated in FIG. 6, at and after cycle 15, the charge capacity of the example cell (labeled “1”) was generally higher than the charge capacity of comparative example cell (labeled “2”). As such, the example cell, with an example of the carbon coating on the negative electrode, showed better capacity retention than the comparative examples cell, which included a pristine, uncoated negative electrode.

It is to be understood that the ranges provided herein include the stated range and any value or sub-range within the stated range. For example, a range of about 1 nm to about 1 μm should be interpreted to include not only the explicitly recited limits of about 1 nm to about 1 μm, but also to include individual values, such as 5 nm, 75 nm, 0.5 μm, etc., and sub-ranges, such as from about 10 nm to about 0.25 μm; from about 50 nm to about 50 nm, etc. Furthermore, when “about” is utilized to describe a value, this is meant to encompass minor variations (up to +/−5%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A coated electrode, comprising:
a negative electrode including:
an active material selected from the group consisting of lithium, silicon, silicon oxide, a silicon alloy, graphite, germanium, tin, antimony, or a metal oxide;
a conductive filler; and
a polymer binder; and
a carbon coating adhered to a surface of the negative electrode, the carbon coating including a percentage of a ratio of sp² carbon:sp³ carbon ranging from 100% (100:0) to 0% (0:100).

2. The coated electrode as defined in claim 1 wherein the carbon coating has a Young's modulus ranging from about 5 GPa to about 200 GPa, a hardness ranging from about 1 GPA to about 20 GPa, and a density of about 2.23 g cm⁻³.

3. The coated electrode as defined in claim 1 wherein the carbon coating has a thickness ranging from about 1 nm to about 1 μm.

4. The coated electrode as defined in claim 1, further including a solid electrolyte interface (SEI) layer formed on the carbon coating.

5. A method for making a coated electrode, the method comprising:
simultaneously exposing a solid graphite target to a plasma treatment and an evaporation treatment, thereby depositing a carbon coating on a surface of a negative electrode, the carbon coating having a percentage of a ratio of sp² carbon:sp³ carbon ranging from about 100% (100:0) to 0% (0:100).

6. The method as defined in claim 5 wherein the simultaneous exposure is accomplished using pulsed laser deposition, a combination of cathodic arc deposition and laser arc deposition, a combination of plasma exposure and laser arc deposition, a combination of plasma exposure and electron beam (e-beam) exposure, magnetron sputtering, or plasma enhanced physical vapor deposition.

7. The method as defined in claim 5 wherein the carbon coating is deposited at a maximum deposition rate ranging from about 48 nm/min to about 100 nm/min.

8. The method as defined in claim 5 wherein the simultaneous exposure is accomplished using pulsed laser deposition, and wherein the pulsed laser deposition includes a pulse repetition rate ranging from about 1 KHz to about 10 KHz.

9. A lithium-based battery, comprising:
the coated electrode of claim 1, wherein the carbon coating is positioned adjacent to a first surface of a separator;
a positive electrode including an active material, the positive electrode positioned adjacent to a second surface of the separator that is opposed to the first surface; and
an electrolyte solution the separator, the negative electrode, and the positive electrode.

10. The lithium-based battery as defined in claim 9 wherein the carbon coating has a thickness ranging from about 1 nm to about 1 μm.

11. The lithium-based battery as defined in claim 9 wherein the coated electrode further includes an SEI layer formed on the carbon coating and positioned between the carbon coating and the separator.

12. The lithium-based battery as defined in claim 9 wherein the lithium-based battery is a lithium ion battery.

13. The lithium-based battery as defined in claim 9 wherein the lithium-based battery is a lithium-sulfur battery.
